(19) United States
(12) Patent Application Publication
(10) Pub. No.: US 2013/0268672 A1
(43) Pub. Date: Oct. 10, 2013

(54) Multi-Objective Virtual Machine Placement Method and Apparatus

(71) Applicants: Valerie D. Justafort, Town Mount Royal (CA); Yves Lemieux, Town Mount Royal (CA)

(72) Inventors: Valerie D. Justafort, Town Mount Royal (CA); Yves Lemieux, Town Mount Royal (CA)

(21) Appl. No.: 13/440,549

(22) Filed: Apr. 5, 2012

(51) Int. Cl. G06F 15/173; G06F 9/455

(52) U.S. Cl. 709/226

(57) ABSTRACT

A cloud network includes a plurality of geographically distributed data centers each having processing, bandwidth and storage resources for hosting and executing applications, a processing node and a database. The processing node determines an optimal placement of a plurality of VMs across the data centers based on a plurality of objectives including at least two of energy consumption by the VMs, cost associated with placing the VMs, performance required by the VMs and VM redundancy. The processing node also allocates at least some of the processing, bandwidth and storage resources of the data centers to the VMs based on the determined optimal placement so that the VMs are placed within a cloud network based on at least two different objectives. The database is configured to store the objectives and information pertaining to the allocation of the processing, bandwidth and storage resources of the data centers.

### TECHNICAL FIELD

The present invention generally relates to cloud computing, and more particularly relates to placing virtual machines (VMs) in a cloud network.

### BACKGROUND

A VM is an isolated ‘guest’ operating system installed within a normal host operating system, and implemented with either software emulation, hardware virtualization or both. With cloud computing, virtual machines (VMs) are used to run applications as virtual containers. Multiple VMs can be placed within a cloud network on a per data center basis, each data center having processing, bandwidth and storage resources for hosting and executing applications associated with the VMs. VMs are typically allocated statically and/or dynamically either only intra data center or inter data center, but not both.

Another conventional practice is to place VMs regardless of the characteristics of the traffic supported by the VMs, but instead to support very specific applications such as HPC (high performance computing), HD (high definition) video, thin clients, etc. For example, if HPC is selected, specialized VMs must be used which can provide high computational capacities with multi-cores. This is in contrast to an HD video VM which must account for real-time characteristics.

Conventional VM optimizations are also very specific in terms of only one field of optimization at a time (i.e. one objective) such as performance or cost, but not both. Furthermore, typical cloud networks often experience failures such as failures that may last for long periods of time. Such failures disrupt services provided by operators because VMs typically are not placed with redundancy or resiliency as a consideration. VMs therefore are not placed optimally based on the aforementioned considerations.

### SUMMARY

Described herein are embodiments for better optimizing the optimization of VM (virtual machine) placement within a cloud network. A multi-objective optimization function considers multiple objectives such as energy consumption, VM performance, utilization cost and redundancy when placing the VMs. Intra data center, inter data center and overall network variables may also be considered when placing the VMs to enhance the optimization. This approach ensures that the VM characteristics are properly supported. Redundancy or resiliency can also be determined and considered as part of the VM placement process.

According to an embodiment of a method of placing VMs within a cloud network, the method comprises: determining an optimal placement of a plurality of VMs across a plurality of geographically distributed data centers based on a plurality of objectives including at least two of energy consumption by the plurality of VMs, cost associated with placing the plurality of VMs, performance required by the plurality of VMs and VM redundancy, each data center having processing, bandwidth and storage resources; and allocating at least some of the processing, bandwidth and storage resources of the geographically distributed data centers to the plurality of VMs based on the determined optimal placement so that the plurality of VMs are placed within the cloud network based on at least two different objectives.

According to an embodiment of a VM management system, the system comprises a processing node configured to determine an optimal placement of a plurality of VMs across a plurality of geographically distributed data centers based on a plurality of objectives including at least two of energy consumption by the plurality of VMs, cost associated with placing the plurality of VMs, performance required by the plurality of VMs and VM redundancy, each data center having processing, bandwidth and storage resources. The processing node is further configured to allocate at least some of the processing, bandwidth and storage resources of the geographically distributed data centers to the plurality of VMs based on the determined optimal placement so that the plurality of VMs are placed within a cloud network based on at least two different objectives. The VM management system also comprises a database configured to store the plurality of objectives and information pertaining to the allocation of the processing, bandwidth and storage resources of the geographically distributed data centers.

According to an embodiment of a cloud network, the cloud network comprises a plurality of geographically distributed data centers each having processing, bandwidth and storage resources for hosting and executing applications, a processing node and a database. The processing node is configured to determine an optimal placement of a plurality of VMs across the plurality of geographically distributed data centers based on a plurality of objectives including at least two of energy consumption by the plurality of VMs, cost associated with placing the plurality of VMs, performance required by the plurality of VMs and VM redundancy. The processing node is further configured to allocate at least some of the processing, bandwidth and storage resources of the geographically distributed data centers to the plurality of VMs based on the determined optimal placement so that the plurality of VMs are placed within a cloud network based on at least two different objectives. The database is configured to store the plurality of objectives and information pertaining to the allocation of the processing, bandwidth and storage resources of the geographically distributed data centers.

Those skilled in the art will recognize additional features and advantages upon reading the following detailed description, and upon viewing the accompanying drawings.

### BRIEF DESCRIPTION OF THE DRAWINGS

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 is a block diagram of an embodiment of a cloud network including a Virtual Machine (VM) management system.

FIG. 2 is a block diagram of an embodiment of the VM management system including a VM processing node and a database.

FIG. 3 is a block diagram of an embodiment of the VM processing node including a VM placement optimizer module.

FIG. 4 is a block diagram of an embodiment of an apparatus for interfacing between the VM processing node and the database.

FIG. 5 is a flow diagram of an embodiment of a method of placing VMs within a cloud network.

### DETAILED DESCRIPTION

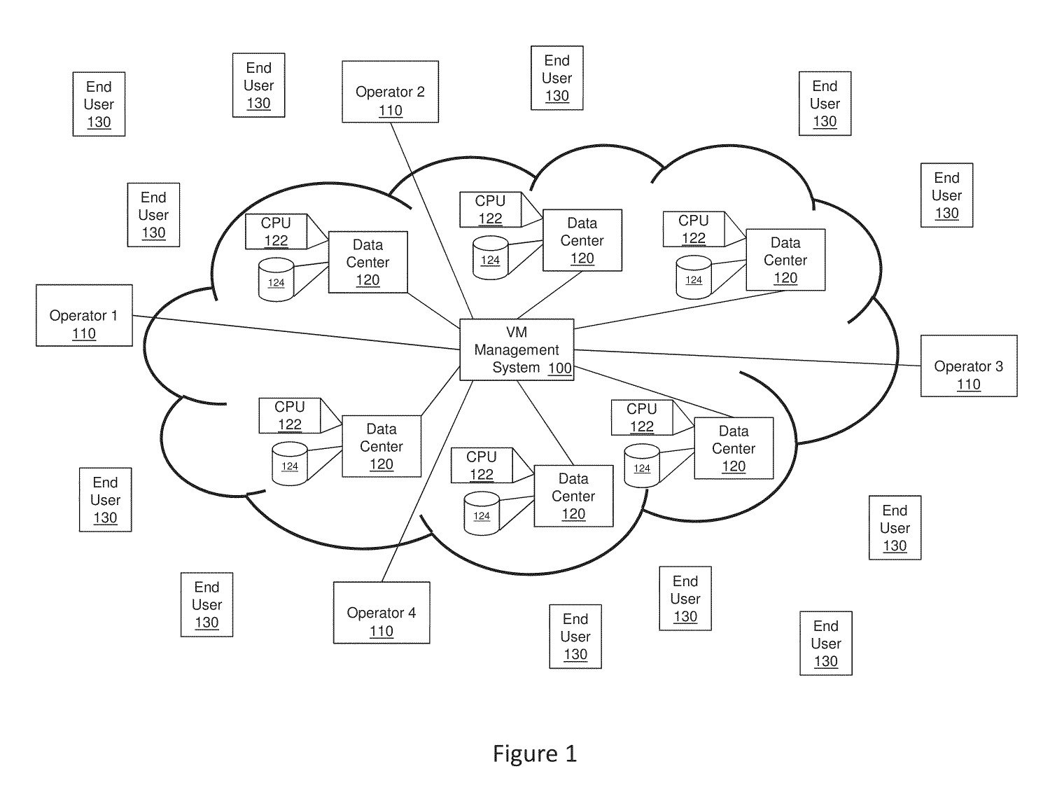

As a non-limiting example, FIG. 1 illustrates an embodiment of a cloud network including a Virtual Machine (VM) management system 100 e.g. owned by a service provider that supplies pools of computing, storage and networking resources to a plurality of operators 110. The operators 110 can be associated to one or more geographically located data centers 120, where applications requested by the corresponding operator 110 are hosted and executed using VMs. A multitude of end users 130 subscribe to the various services offered by the operators 110.

The VM management system 100 determines an optimal placement of the VMs across the geographically distributed data centers 120 based on a plurality of objectives including at least two of energy consumption by the VMs, cost associated with placing the VMs, performance required by the VMs, and VM redundancy. The VM management system 100 allocates at least some of the processing, bandwidth and storage resources 122, 124 of the data centers 120 to the VMs based on the determined optimal placement so that the VMs are placed within the cloud network based on at least two different objectives.

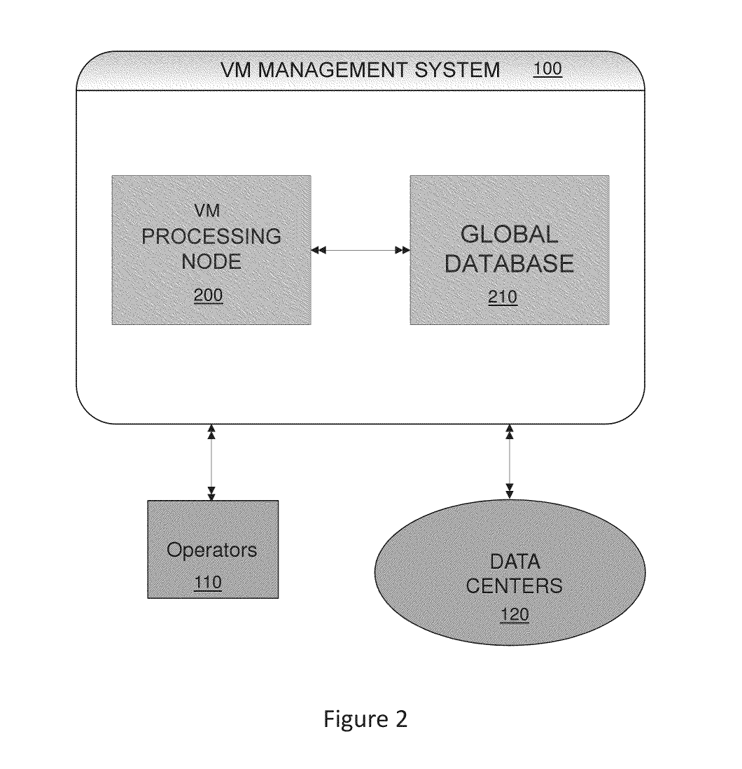

FIG. 2 illustrates an embodiment of the VM management system 100. The VM management system 100 includes a VM processing node 200 which computes and evaluates different VM configurations and provides an optimal VM placement solution based on more than a single objective. The VM management system 100 also includes a database 210 where information related to VMs states, operator profiles, data center capabilities, etc. are stored. According to an embodiment, the database 210 stores information relating to the objectives used to determine the VM placement and also information relating to the allocation of the processing, bandwidth and storage resources 122, 124 of the geographically distributed data centers 120. The VM management system 100 communicates with the operators 110 and the data centers 120 through specific adapters which are not shown in FIG. 2.

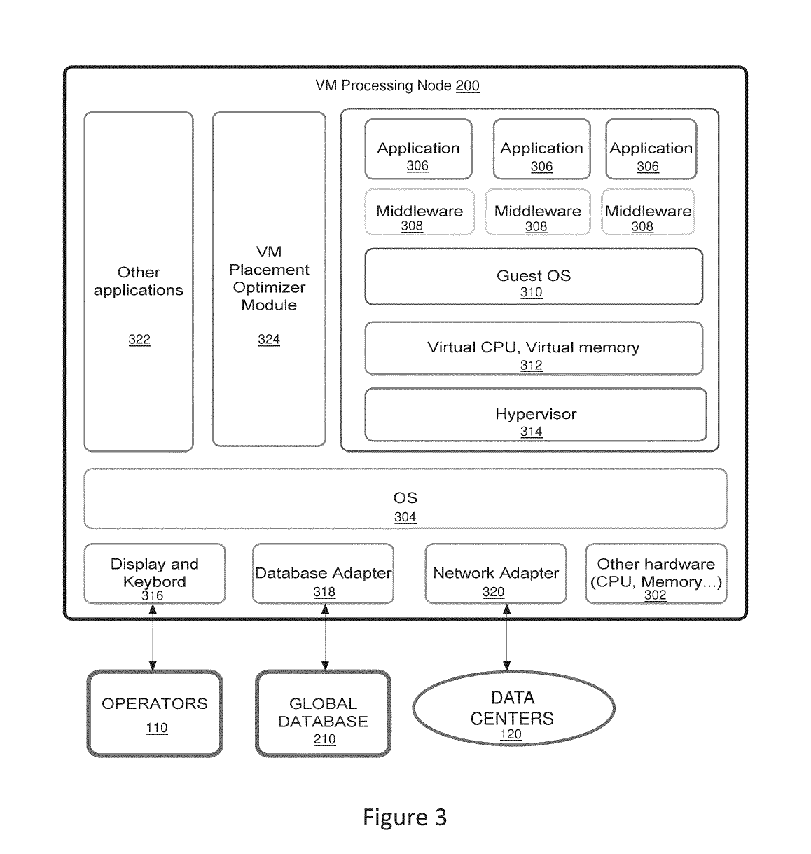

FIG. 3 illustrates an embodiment of the VM processing node 200. The VM processing node 200 has typical computing, storage and memory capabilities 302. The VM processing node 200 also has an operating system (OS) 304 that mainly controls scheduling and access to the resources of the processing node 200. The VM processing node 200 further includes VMs including corresponding related components such as applications 306, middleware 308, guest operating systems 310 and virtual hardware 312. A hypervisor 314, which is a layer of system software that runs between the main operating system 304 and the VMs, is responsible for managing the VMs. The VM processing node 200 communicates with the operators 110 through an interface formed by, for example, a display and a keyboard 316. The VM processing node 200 is connected to the database 210 and to the data centers 120 through, respectively, a database adapter 318 and a network adapter 320. The VM processing node 200 also includes other applications 322 and a VM placement optimizer module 324. The VM placement optimizer module 324 determines the optimal placement of the VMs according to a multi-objective function and also optionally application priorities.

For example, an operator 110 can choose the level of optimization among different objectives. A multi-objective VM placement function implemented by the VM placement optimizer module 324 allows the operator 110 to consider different objectives in the VM placement process, such as energy and deployment cost reduction, performance optimization, and redundancy. A set of geographically located data centers 120 represents a good environment for such optimization.

For example with several data centers 120 set up at different geographical locations, resource availability and time varying load coordination e.g. due to the high mobility of end-users can be readily addressed. In this way, a scalable environment is provided which supports dynamic contraction and expansion of services in response to load variation and/or changes in the geographic distribution of the users 130.

Also, a set of geographically distributed data centers 120 provides for VM back-up at a different location in the event of a data center failure and also migration of running VMs to another physical location in the event of a data center failure or shutdown.

Furthermore, all data centers 120 most likely are not identical in a cloud network. For example, it is not uncommon to find data centers 120 where sophisticated cooling mechanisms are used in order to optimize the effectiveness of the data center 120, in terms of energy consumption, thus reducing the carbon footprint of hosted applications. Also, price charged per unit of resource may vary by location. In order to minimize the energy consumed by the VMs or to reduce the overall deployment cost of hosted applications, a set of geographically distributed data centers 120 represents a more suitable environment to operate such optimization as compared to a single data center.

Service providers also place requested applications into available servers as a function of their performance. VM mapping to physical machines can have a deep impact on the performance of the hosted applications. For example, the emergence of social networking, video-on-demand and thin client applications requires running different copies of such services in geographically distributed data centers 120 while assuring bandwidth availability and low latency. In addition, quality of service (QoS) requirements depend on the application type and user location. The process of VM placement is more optimal by finding the appropriate data centers 120 for such hosted applications.

The VM placement optimizer module 324 weighs such considerations when determining an optimal placement of the VMs. According to an embodiment, the VM placement optimizer module 324 implements a multi-objective VM placement function given by:

F(z)=αE(z)+βP(z)+λC(z)+ΩR(z) (1)

where α, β, λ and Ω are scaling factors for use by the operator 110 in deciding how to weight the different objectives included in the global function F(z).

The first objective E(z) in equation (1) relates to the energy consumed by the VMs and is given by:

E(z)=ΣpueⁱCᵢⱼ^{t}U_{CPU}(sₘⱼ^{t}) (2)

The energy consumption objective E(z) depends on the power usage effectiveness (pue^{j}) of the data centers 120, server type (C) and computing resources (U_{CPU}(sₘⱼ^{t})) consumed by the VMs.

The second objective P(z) in equation (1) relates to the performance required by the VMs and is given by:

P(z)=Σ(Cₙₙ [symbol] ^{VM}Lₘⱼ_{_{—}}ₘ [symbol] ⱼ [symbol] ^{t}^{_{—}}^{t} [symbol] +CₙᵤLᵤⱼ+|U_{BW}(sₘⱼ^{t})−Moy_{BW}(pⱼ)|) (3)

The performance objective P(z) depends on latency between two communicating VMs (Cₙₙ [symbol] ^{VM}Lₘⱼ_{_{—}}ₘ [symbol] ⱼ [symbol] ^{t}^{_{—}}^{t} [symbol] ), latency between a VM and an end-user (CₙᵤLᵤⱼ) and network congestion (|U_{BW}(sₘⱼ^{t})−Moy_{BW}(pⱼ)|). One or more additional (optional) terms may be included in equation (3), e.g. which correspond to VM consolidation (colocation) and server over-utilization. The performance objective P(z) tends to minimize the overall latency in the cloud network, while reducing network congestion. The last term in equation (3) |U_{BW}(sₘⱼ^{t})−Moy_{BW}(pⱼ)| tends to minimize network congestion via load balancing.

The third objective C(z) in equation (1) relates to the cost associated with placing the VMs and is given by:

C(z)=Σ(C_{CPU}^{tj}C_{CPU}(aᵥ_{_{—}}ᵢ^{u})+C_{BW}^{j}C_{BW}(aᵥ_{_{—}}ᵢ^{u}+C_{STO}^{sj}C_{STO}(aᵥ_{_{—}}ᵢ^{u})) (4)

The cost objective C(z) refers to the deployment and the utilization cost related to the hosted VMs in terms of allocating the processing, bandwidth and storage resources 122, 124 of the data centers 120. The cost objective C(z) depends on a server type and data center type cost variable represented by t in equation (4), a price-per-unit of each available data center resource and an amount of data center processing (CPU), bandwidth (BW) and storage (STO) resources to be consumed by the VMs.

The fourth objective R(z) in equation (1) relates to VM redundancy and is given by:

R(z)=f(n,m,statₙ) (5)

The VM redundancy objective R(z) refers to the operation of n VMs with m VMs as back-ups. The VM redundancy objective R(z) tends to place the m back-up VMs by considering the n running VMs and their related statuses. The m back-up VMs can be allocated to data centers 120 in order to avoid single point of failure, while taking into account the energy, cost and performance (statₙ) of the n running VMs. Accordingly, the VM redundancy objective R(z) depends on the number of operational VMs (n) and number of redundant or back-up VMs (m).

The VM placement optimizer module can use binary values (1 or 0) for the variables included in the multi-objective VM placement function given by equation (1). Alternatively, decimals, mixed-integer or some combination thereof can be used for the objective variables.

The VM placement optimizer module 324 can limit the placement of the VMs across the data centers 120 based on one or more constraints such as a maximum capacity of each data center 120, a server and/or data center allocation constraint for one or more of the VMs, and an association constraint limiting which users 130 can be associated with which data centers 120. The capacity constraint ensures that the capacity of allocated VMs does not exceed the maximum capacity of a given data center 120. The VM allocation constraint ensures that a VM is allocated to only one data center 120. The user constraint ensures a group of users 130 is associated to one or more particular data centers 120. The placement of the VMs across the geographically distributed data centers 120 can be modified or adjusted responsive to one or more of the constraints being violated. For example, a particular data center 120 can be eliminated from consideration if one of the constraints is violated by using that data center 120.

The VM placement optimizer module 324 can also consider prioritization of the different applications associated with the VMs when determining the optimal placement of the VMs across the geographically distributed data centers 120. This way, higher priority applications are given greater weight (consideration) than lower priority applications when determining how the processing, bandwidth and storage resources 122, 124 of the data centers 120 are to be allocated among the VMs. The VM placement optimizer module 324 can update the results responsive to one or more modifications to the cloud network.

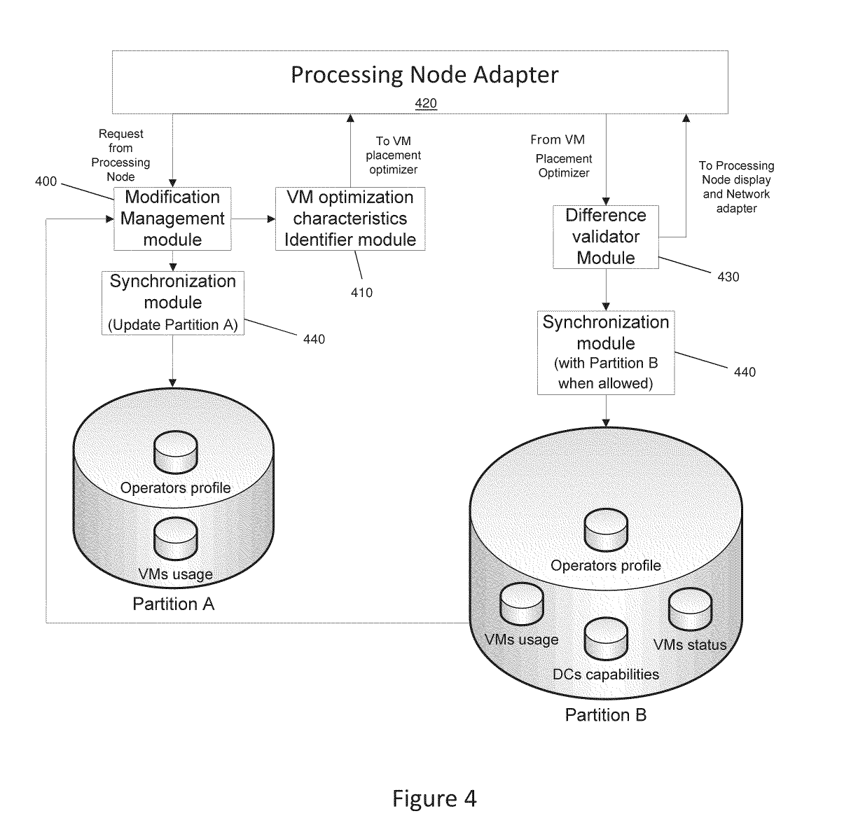

FIG. 4 illustrates an embodiment of an apparatus which includes a state database (labeled Partition B in FIG. 4) that tracks the operator profiles e.g. level of optimization, amount of VMs per class, etc., VM usage in terms of VM characteristics, data center capabilities and the state of all allocated VMs. The apparatus also includes a second database partition (labeled Partition A in FIG. 4) that tracks all temporary modifications not only in terms of added/subtracted resources, but also changes related to the operator profiles. The apparatus also includes a modification management module 400 and a VM characteristic identifier module 410 that manage the user requests and transmits the optimization characteristics to the VM placement optimizer module 324 located in the VM processing node 200, via a processing node adapter 420. A difference validator module 430 is also provided for deciding whether a newly determined VM configuration is valid with respect to the changes to the objectives made in accordance with equation (1) and the applications priorities. A synchronization module 440 is also provided for allowing the network administrator to synchronize the new entries to the database partitions. The modification management module 400, the VM characteristic identifier module 410, the difference validator module 430 and the synchronization module 440 can be included in the same VM management system 100 as the VM processing node 200.

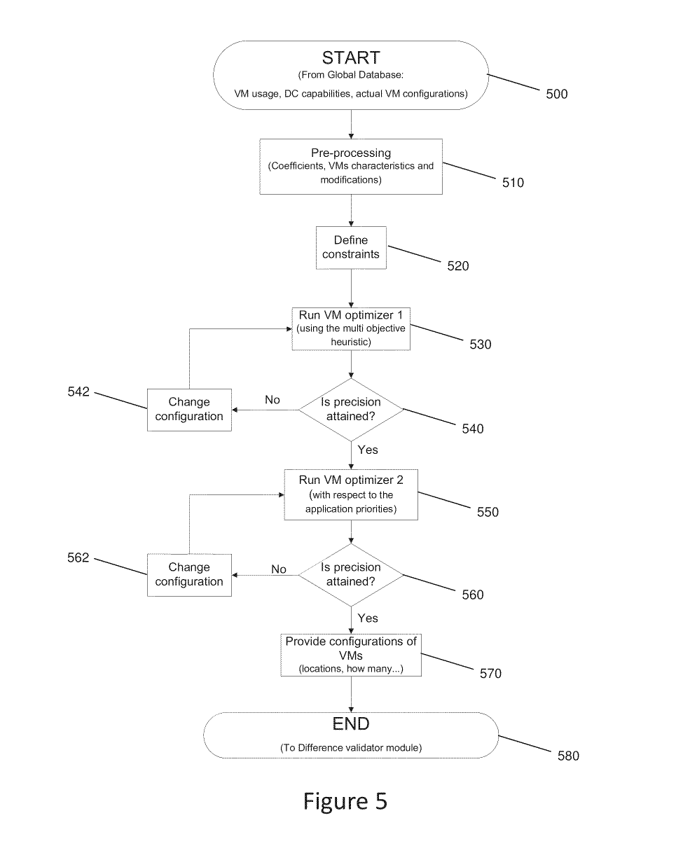

FIG. 5 illustrates an embodiment of a method of placing the VMs within the cloud network as implemented by the VM placement optimizer module 324. The method includes receiving information from the database 210 related to an operator request for VM placement optimization, including data such as VM usage, data center (DC) capabilities, VM configurations, etc. (Step 500). A pre-processing step is then performed to determine the coefficients to be used in the multi-objective VM placement function of equation (1), the VM characteristics and all other parameters related to the optimization process (Step 510). Constraints related to the VM location and data center capabilities are also defined (Step 520). The multi-objective heuristic is then run to determine the optimal placement of the VMs with respect to the objective function (Step 530). Once a desired precision is attained (Steps 540, 542), a second optimization process can be run to find the optimal placement of the virtual machines with respect to the application priorities (Step 550). Once a desired precision is attained (Steps 560, 562), the best configuration is then submitted to the difference validator module 430 (Steps 570, 580). Upon validation by the difference validator module 430, the VMs are deployed, removed and/or migrated based on the optimization results. That is, at least some of the processing, bandwidth and storage resources 122, 124 of the geographically distributed data centers 120 are allocated to the VMs based on the optimal placement determined by the VM placement optimizer module 324 so that the VMs are placed within the cloud network based on at least two different objectives.

Described next is a purely illustrative example of the multi-objective VM placement function of equation (1) as implemented by the VM placement optimizer module 324, for the energy consumption and cost objectives E(z) and C(z). Accordingly, the scaling factors β and are set to zero so that the performance and redundancy objectives P(z) and R(z) are not a factor. In order to minimize the multi-objective VM placement function, the VM placement optimizer module 324 tends to place VMs where the consumed energy and deployment cost are low.

To evaluate the effectiveness of the VM placement process, different situations can be considered in a hypothetical cloud computing environment having e.g. one service provider, three data centers and one operator. For ease of illustration, only one class of VM is considered. Under these exemplary conditions, the multi-objective VM placement function of equation (1) reduces to:

F(z)=αE(z)+λC(z) (6)

where β and Ω have been set to zero. The characteristics of the data centers are presented below:

TABLE 1
Data centers characteristics

| Data | CPU- | STOR | BW | | | | | |
|---|---|---|---|---|---|---|---|---|
| Center | hours | (GBs) | (MBs/day) | PUE | C1j | Ccpu | Cbw | Csto |
| DC1 | 360 | 1000 | 5900 | 1.3 | 1 | 0.4 | 0.1 | 0.8 |
| DC2 | 480 | 2000 | 660 | 1.1 | 1 | 0.6 | 0.3 | 0.6 |
| DC3 | 1200 | 1000 | 4700 | 1.2 | 1 | 0.5 | 0.25 | 0.7 |

where CPU-hours is the available processing resources at each data center (DC1, DC2, DC3), STOR is the available storage capacity at each data center and BW is the available bandwidth at each data center.

The characteristics of the VM class (V1) are listed in Table 2 in terms of the available processing resources at each data center (CPU-hours), the available storage capacity at each data center (STOR) and the available bandwidth at each data center (BW).

TABLE 2
VM characteristics

| VC/ | CPU- | STOR | BW |
|---|---|---|---|
| Res | hours | (GBs) | (MBs/day) |
| V1 | 60 | 100 | 147.5 |

Considering the VM characteristics and the data center capacities, the maximum number of VMs that can be allocated to a given data center is provided in Table 3.

TABLE 3
Maximum number of VMs per DC

| DC | DC1 | DC2 | DC3 |
|---|---|---|---|
| # VMS | 6 | 4 | 10 |

With three data centers, one operator and seven VMs, there are 36 placement possibilities for the VMs within the cloud network as depicted by Table 4. However, the shaded rows represent unfeasible solutions, due to data center capacity limitations.

TABLE 4
Different combinations

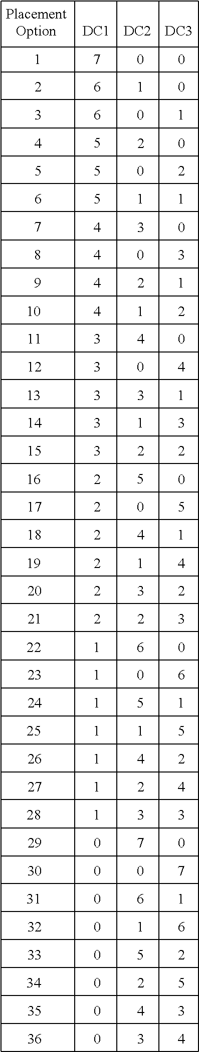

In Table 4, the lowest energy consumption is obtained with the 29^{th} configuration option i.e. with all seven VMs placed in the second data center (where the pue for the 29^{th} configuration option is 1.1—the lowest). However, due to data center capacity constraints, this solution is unfeasible as indicated in Table 4. Therefore, the most feasible solution that achieves the lowest energy consumption is the 35^{th} configuration option i.e. with four VMs placed in the second data center (DC2) and three VMs placed in the third data center (DC3).

If only deployment cost is considered, different results are obtained. However, the lowest deployment cost option is also obtained with an unfeasible solution—the 1^{st} configuration option. The most feasible deployment cost optimization is provided using the 3^{rd} configuration option i.e. by placing six VMs in the first data center (DC1) and one VM in the third data center (DC3).

These two previous results suggest it is not always possible to achieve energy optimization and deployment cost minimization through the same exact configuration. However, by utilizing the multi-objective VM placement function given in equation (6) with the coefficients α and λ set to 1, the 2^{nd} configuration option provides the overall optimal VM placement solution.

Not only is a different optimal configuration provided by using the multi-objective evaluation, but it is also possible to conclude that in a could computing environment, even with only one class of VM, the best solution is not trivial, for it does not only imply to consider each parameter separately then aggregating the results, but to find the best by accounting for multiple criteria (objectives) simultaneously.

Terms such as “first”, “second”, and the like, are used to describe various elements, regions, sections, etc. and are not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

It is to be understood that the features of the various embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of placing virtual machines (VMs) within a cloud network, comprising:
determining an optimal placement of a plurality of VMs across a plurality of geographically distributed data centers based on a plurality of objectives including at least two of energy consumption by the plurality of VMs, cost associated with placing the plurality of VMs, performance required by the plurality of VMs and VM redundancy, each data center having processing, bandwidth and storage resources; and
allocating at least some of the processing, bandwidth and storage resources of the geographically distributed data centers to the plurality of VMs based on the determined optimal placement so that the plurality of VMs are placed within the cloud network based on at least two different objectives.

2. A method according to claim 1, further comprising applying a scaling factor to each objective used in computing the optimal placement of the plurality of VMs.

3. A method according to claim 1, wherein the energy consumption objective depends on a power usage effectiveness of the plurality of data centers, server type and computing resources consumed by the plurality of VMs.

4. A method according to claim 1, wherein the cost objective depends on a price-per-unit of each available data center resource, server type, storage type, and an amount of data center resources to be consumed by the plurality of VMs.

5. A method according to claim 1, wherein the performance objective depends on latency between two communicating VMs, latency between a VM and an end-user and network congestion.

6. A method according to claim 5, wherein the performance objective further depends on consolidation of the VMs and server over-utilization.

7. A method according to claim 1, wherein the VM redundancy objective depends on a number of operational VMs and a number of redundant VMs.

8. A method according to claim 1, further comprising constraining the optimal placement of the plurality of VMs across the plurality of geographically distributed data centers based on at least one of the following constraints:
a maximum capacity of each data center;
an allocation constraint for one or more of the plurality of VMs; and
an association constraint limiting which users can be associated with which data centers.

9. A method according to claim 1, wherein the plurality of objectives are based on binary variables.

10. A method according to claim 1, wherein the optimal placement of the plurality of VMs across the plurality of geographically distributed data centers is further determined based on a prioritization of different applications associated with the plurality of VMs.

11. A method according to claim 1, further comprising modifying the optimal placement of the plurality of VMs across the plurality of geographically distributed data centers responsive to one or more constraints being violated.

12. A method according to claim 1, further comprising:
determining the optimal placement of the plurality of VMs is valid; and
in response, updating a database with information pertaining to the data center resource allocations.

13. A virtual machine (VM) management system, comprising:
a processing node configured to:
determine an optimal placement of a plurality of VMs across a plurality of geographically distributed data centers based on a plurality of objectives including at least two of energy consumption by the plurality of VMs, cost associated with placing the plurality of VMs, performance required by the plurality of VMs and VM redundancy, each data center having processing, bandwidth and storage resources; and
allocate at least some of the processing, bandwidth and storage resources of the geographically distributed data centers to the plurality of VMs based on the determined optimal placement so that the plurality of VMs are placed within a cloud network based on at least two different objectives; and
a database configured to store the plurality of objectives and information pertaining to the allocation of the processing, bandwidth and storage resources of the geographically distributed data centers.

14. A VM management system according to claim 13, wherein the processing node is further configured to apply a scaling factor to each objective used in computing the optimal placement of the plurality of VMs.

15. A VM management system according to claim 13, wherein the energy consumption objective depends on a power usage effectiveness of the plurality of data centers, server type and computing resources consumed by the plurality of VMs.

16. A VM management system according to claim 13, wherein the cost objective depends on a price-per-unit of each available data center resource, server type, storage type, and an amount of data center resources to be consumed by the plurality of VMs.

17. A VM management system according to claim 13, wherein the performance objective depends on latency between two communicating VMs, latency between a VM and an end-user and network congestion.

18. A VM management system according to claim 17, wherein the performance objective further depends on consolidation of the VMs and server over-utilization.

19. A VM management system according to claim 13, wherein the VM redundancy objective depends on a number of operational VMs and a number of redundant VMs.

20. A VM management system according to claim 13, wherein the processing node is further configured to constrain the optimal placement of the plurality of VMs across the plurality of geographically distributed data centers based on at least one of the following constraints:
a maximum capacity of each data center;
an allocation constraint for one or more of the plurality of VMs; and
an association constraint limiting which users can be associated with which data centers.

21. A VM management system according to claim 13, wherein the plurality of objectives are based on binary variables.

22. A VM management system according to claim 13, wherein the processing node is configured to determine the optimal placement of the plurality of VMs across the plurality of geographically distributed data centers further based on a prioritization of different applications associated with the plurality of VMs.

23. A VM management system according to claim 13, wherein the processing node is further configured to modify the optimal placement of the plurality of VMs across the plurality of geographically distributed data centers responsive to at least one of one or more constraints being violated and one or more modifications to the cloud network.

24. A VM management system according to claim 13, wherein the processing node is further configured to determine the optimal placement of the plurality of VMs is valid and in response, update the database with information pertaining to the data center resource allocations.

25. A cloud network, comprising:
a plurality of geographically distributed data centers each having processing, bandwidth and storage resources for hosting and executing applications;
a processing node configured to:
determine an optimal placement of a plurality of VMs across the plurality of geographically distributed data centers based on a plurality of objectives associated with placing the plurality of VMs, performance required by the plurality of VMs and VM redundancy; and
allocate at least some of the processing, bandwidth and storage resources of the geographically distributed data centers to the plurality of VMs based on the determined optimal placement so that the plurality of VMs are placed within a cloud network based on at least two different objectives; and
a database configured to store the plurality of objectives and information pertaining to the allocation of the processing, bandwidth and storage resources of the geographically distributed data centers.
